(19) United States
(12) Patent Application Publication
(10) Pub. No.: US 2009/0225390 A1
(43) Pub. Date: Sep. 10, 2009

(54) FEEDBACK SYSTEM AND FEEDBACK METHOD FOR CONTROLLING POWER RATIO OF INCIDENT LIGHT

(76) Inventors: Chia-Wei Lin, Taipei City (TW); Teng-Yen Huang, Taipei City (TW); Chun-Cheng Liao, Taipei County (TW)

Correspondence Address: NORTH AMERICA INTELLECTUAL PROPERTY CORPORATION, P.O. BOX 506, MERRIFIELD, VA, 22116, US

(21) Appl. No.: 12/129,693

(22) Filed: May 30, 2008

(30) Foreign Application Priority Data
Mar. 5, 2008 (TW) 097107679

(51) Int. Cl. G02F 1/01

(52) U.S. Cl. 359/239

(57) ABSTRACT

A feedback system and method for controlling TE/TM power ratio of light source is proposed. A specially-designed mark is positioned on the mask. The mark and the mask are illuminated by incident light emanated from the light source, and the reflected light or the refracted light of the incident light is detected to provide an output signal. Then, the signal is input into a polarization converter. In this way, the TE/TM polarization power ratio of the light source can be controlled.

### BACKGROUND OF THE INVENTION

1. Field of the Invention

The present invention is related to a feedback system and a feedback method for controlling power ratio of incident light.

2. Description of the Prior Art

As the integration of ICs increases the critical dimension of semiconductors becomes smaller. Therefore, it is desirable to increase the resolution limit of optical exposure tools. A conventional method for improving resolution includes the steps of: off-axis illumination, immersion lithography and increasing the numerical aperture of the lens. As the resolution increases, mask induced polarization may occur.

In general, a mask is composed of a mask substrate and a patterned metal layer. The mask substrate can be a quartz substrate, and the patterned metal layer covers the quartz substrate. The light can be defined into two modes: transverse-electric (TE) mode and transverse-magnetic (TM) mode.

Polarization effects can be a concern with the decreasing device dimensions. Based on physical properties, the patterned metal layer has a higher transmittance with respect to the TE mode of the light compared to the TM mode of the light, especially when the incident angle is large. On the contrary, the quartz substrate has a low transmittance with respect to the TE mode of the light. Therefore, even if the TE mode of light passing through the patterned metal layer is utilized, the TE mode of light will be blocked by the quartz substrate before it reaches the wafer. As a result, the product yield will be deteriorated.

It is therefore the primary object of the present invention to provide a feedback system to adjust the polarization power ratio of incident light. By converting the energy of TM mode to TE mode, the energy of the TE mode can be increased when it reaches the wafer. The resolution and yield can thereby be enhanced.

### SUMMARY OF THE INVENTION

From one aspect of the present invention, the present invention provides a feedback method for controlling polarization ratio of incident light.

First, a mask having a mark is provided. Thereafter, the mark is illuminated with incident light. Next, reflected light or refracted light from the illuminated mark is detected to get a first parameter. Afterwards, the first parameter is processed to become a second parameter. Finally, polarization ratio of the incident light is adjusted from the second parameter.

From another aspect of the present invention, the present invention further provides a feedback controlling system including an incident light used to illuminate a mark on a mask, a polarization converter used to control the polarization power ratio of the incident light, a detector used to detect reflected light or refracted light from the illuminated mark to get a parameter, and a processor used to calculate the parameter and send a feedback signal to the polarization converter to adjust the polarization power ratio of the incident light.

The present invention features disposing a mark on the mask substrate. After the energy of the reflected light or the refracted light from the illuminated mark is detected, the TE/TM polarization power ratio of the incident light can be obtained by calculation. Then, the TE/TM polarization power ratio is fed back into the polarization converter used as a base value. After that, the energy of TE mode of the incident light can be increased by the polarization converter.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram illustrating a feedback controlling system in accordance with the first embodiment of the present invention.

FIG. 2 is a schematic diagram illustrating a feedback controlling system in accordance with the second embodiment of the present invention.

FIG. 3 is a schematic diagram illustrating the magnified mark.

FIG. 4 is a schematic diagram illustrating the side view of the mask.

FIG. 5 illustrates the transmittance of the mask with respect to the zero-order incident light in TE mode versus width.

### DETAILED DESCRIPTION

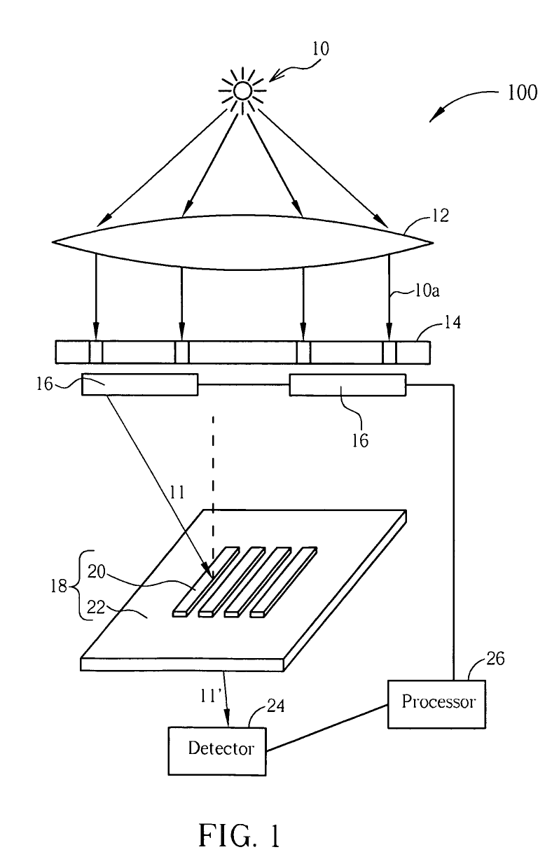

FIG. 1 is a schematic diagram illustrating a feedback controlling system 100 in accordance with the first embodiment of the present invention. As shown in FIG. 1, the a feedback controlling system includes:

(1) A light source 10. Radiant of the light source 10 is focused to become radiant 10a after passing through lens 12. Then, radiant 10a passes through an aperture plate 14.

(2) A polarization converter 16. A TE/TM polarization power ratio of radiant 10a is adjusted by the polarization converter 16 to form incident light 11. A mark 20 on a mask substrate 22 is illuminated by the incident light 11, and the incident light 11 is refracted to form refracted light 11′. The mask substrate 22 can be a quartz substrate, and the mark 20 and the mask substrate 22 form a mask 18.

(3) A detector 24 used to detect the refracted light 11′ from the illuminated portion of the mark 20 to get a parameter. According to a preferred embodiment of the present invention, the parameter can be energy of the refracted light 11′ in TE mode.

(4) A processor 26 used to calculate the parameter. After calculating the parameter, a TE/TM polarization power ratio of the incident light 11 can be obtained. Then the TE/TM polarization power ratio of the incident light 11 will be fed back into the polarization converter 16 to be a feedback signal. In this way, by taking the TE/TM polarization power ratio of the incident light 11 as a base value, the TE/TM polarization power ratio of the radiant 10a will be changed by the polarization converter 16, and then the TE/TM polarization power ratio of the incident light 11 can be adjusted before illuminating the mark 22 again.

The mark 20 can be composed of a plurality of grating lines. Any material that can form the grating lines can be used. There is pitch Λ between the grating lines. According to the preferred embodiment of the present invention, the pitch Λ is smaller than the wavelength of the radiant 10a. In addition, the mask substrate 22 is not limited to the quartz substrate.

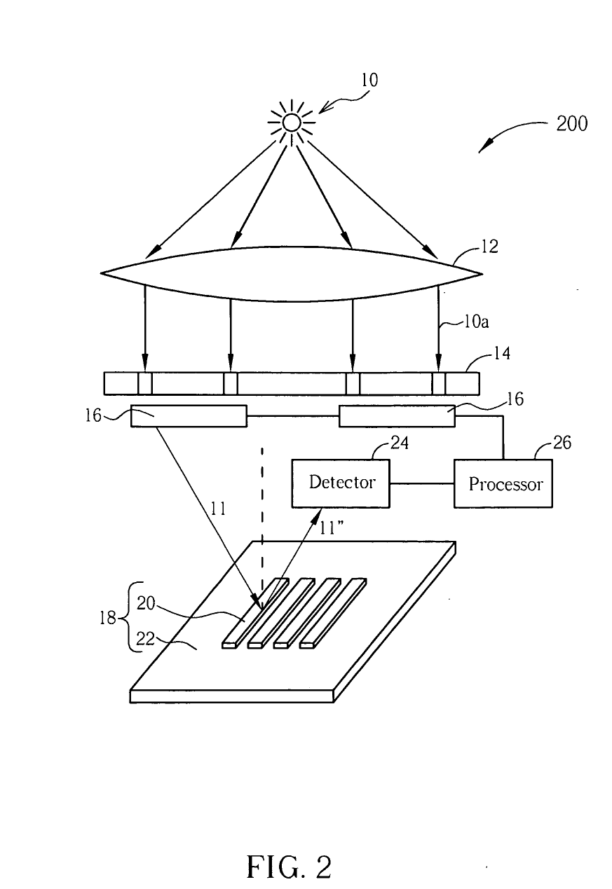

FIG. 2 is a schematic diagram illustrating a feedback controlling system 200 in accordance with the second embodiment of the present invention. To simplify the illustration, elements with the same function will use the same numerals in FIG. 1. As seen in FIG. 2, the radiant 10a passes through lens 12 and the aperture plate 14. Then, the incident light 11 illuminates the mark 20 and mask substrate 22 after going through the polarization converter 16, and a reflected light 11″ is then formed. The first embodiment and the second embodiment only differ in the parameter that the detector 24 detects. The detector 24 in the second embodiment is used to detect the energy of the reflected light 11″ in TM mode, and the detector 24 in the first embodiment is used to detect the energy of the refracted light 11′ in TE mode. Other operations of elements in feedback system 200 are similar with the feedback system 100, and therefore omitted for brevity.

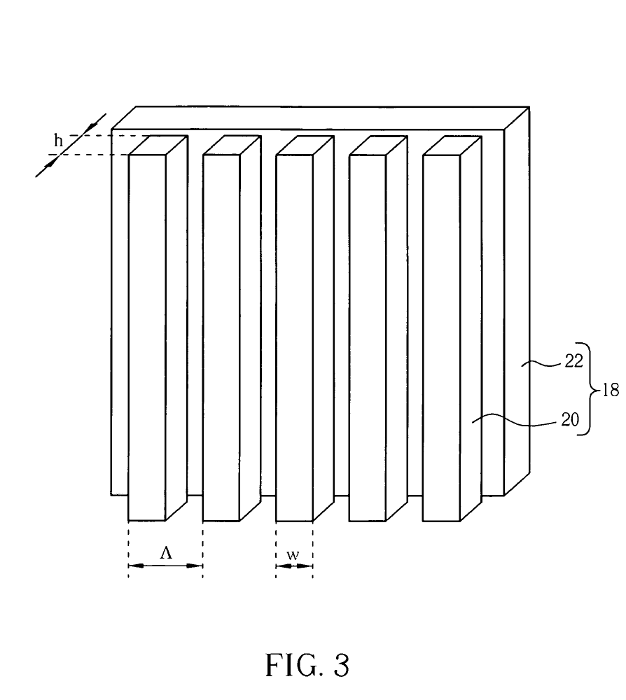

In another embodiment of the present invention, a feedback method for controlling a polarization power ratio of incident light is provided. The feedback method will be described by utilizing the feedback system 100 as an example. FIG. 3 is a schematic diagram illustrating the magnified mark 20. Please refer to FIG. 3 and FIG. 1. As shown in FIG. 1, the mark 20 of the mask 18 is illuminated by the incident light 11. As shown in FIG. 3, the mark 20 is composed of a plurality of grating lines. Each grating line has a width W and a thickness h. The grating lines further include a pitch Λ between each grating line. The mark 20 can be made from conductors, or any materials that can make grating lines. One feature of the present invention is that the width W, the pitch Λ and the thickness h of the mark 20 are specially designed. The design of the mark 20 must take the wavelength of the light source 10, the position of the mask 18 in the system, and the position of the detector 24 into consideration and follow three boundary conditions. The method of designing the mark 20 will be described in detail later. According to a preferred embodiment of the present invention, the pitch Λ of the grating lines is smaller than the wavelength of the radiant 10a.

The method for controlling TE/TM polarization power ratio of incident light is started by measuring the experimental value of the transmittance of mask 18 with respect to the incident light 11. Next, the incident light 11 illuminates the mask 18 and then passes through the mask substrate 22. The illuminated portion of the mark 20 and the mask substrate 22 forms the refracted light 11′. Thereafter, a first parameter such as energy of the refracted light 11′ in TE mode is detected by the detector 24. Subsequently, the energy of the refracted light 11′ in TE mode is sent into the processor 26. Then the second parameter such as the TE/TM polarization power ratio of the incident light 11 can be calculated by the processor 26 by utilizing transmittance of the mask 18 with respect to the incident light 11, the energy of the refracted light 11′ in TE mode, the total energy of the incident light 11 and the reflective index of the mask substrate 22. As one skilled in the art should know, the total energy of the incident light 11 can be measured by an optical power meter, and the reflective index of the mask substrate 22 is based on the material of the mask substrate 22.

Then, the TE/TM polarization power ratio of the incident light 11 is fed back into the polarization converter 16 as a base value. Afterwards, the energy of the radiant 10a in TM mode can be converted to the energy of the radiant 10a in TE mode by the polarization converter 16. Therefore, when the incident light 11 goes into the mask 18 again, the energy of the incident light 11 in TE mode is increased, and the energy of the incident light 11 in TE mode passing through the mask can thereby also be increased.

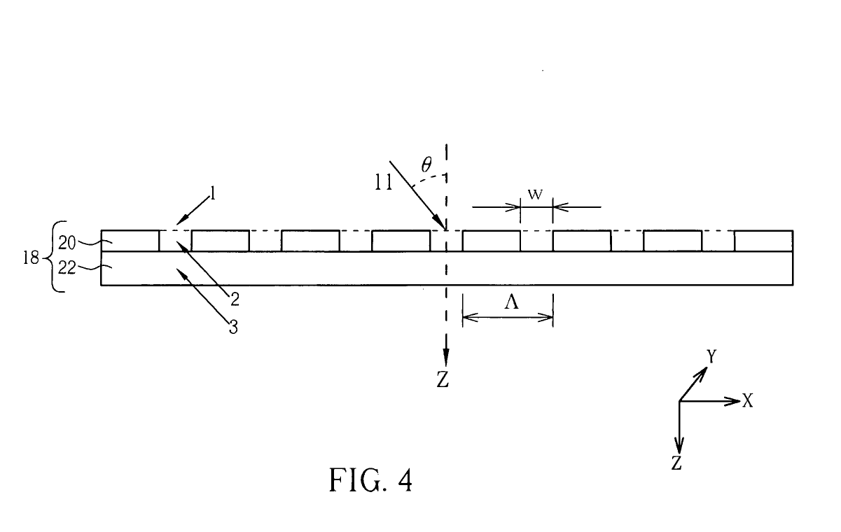

The design method of the mark 20 used in the feedback controlling system 100 is illustrated as follows. FIG. 4 is a schematic diagram illustrating the side view of the mask 18. As shown in FIG. 4, the mark 18 is composed of the mark 20 and the mask substrate 22. The incident light 11 illuminates the mask 18 at an incident angle 0, wherein the incident angle θ is not equal to zero. The region above the top surface of the mark 20 is defined as region 1, and the medium positioned at the region 1 has a refractive index n₁. The region between the grating lines of the mark 20 is defined as region 2, and the medium positioned at the region 2 has a refractive index n₂. The region at the mask substrate 22 is defined as region 3, and the mask substrate 22 has a refractive index n₃. In addition, each grating line of the mark 20 has the width W and the thickness h (not shown in FIG. 4). Moreover, the pitch A is between the grating lines. Furthermore, coordinate axis, X, Y, and Z is shown in the FIG. 4. When the pitch Λ satisfies the Eq. (1), only zero-order light (ground state) can pass through the mark 20.

$$Λ < min [ \frac{λ}{cos φ} ( \frac{λ}{{n}_{1} {n}_{2} sin θ} ) , \frac{1}{cos φ} ( \frac{λ}{{n}_{1} + {n}_{2} sin θ} ) ] \qquad ( 1 )$$

wherein φ=2/π−θ. In this state, the reflective index and the transmittance of the mark 20 are highly related to the polarization of the incident light 11.

There are two common methods of designing the mark having a specific reflective index and transmittance to certain polarized light.

(1) Vector Analysis Method

]Assuming the mark 20 is made from a perfect conductor, the wave function of the electromagnetic wave followed the boundary conditions of the mark 20 can be expressed as follows:

\vec{E}⁽¹⁾=ŷE_{y0}⁽¹⁾e^{i(k}^{_{z}}^{⁽²⁾}^{z+k}^{ₓ}^{⁽¹⁾}^{(x-w/2))} (2)

\vec{E}⁽²⁾=ŷE_{y0}⁽²⁾(e^{i(k}^{_{z}}^{⁽²⁾}^{z+k}^{ₓ}^{⁽²⁾}^{(x+w/2)))}+e^{i(k}^{_{z}}^{⁽²⁾}^{z-k}^{ₓ}^{⁽²⁾}^{(x-w/2))} (3)

\vec{E}⁽³⁾=ŷE_{y0}⁽³⁾e^{i(k}^{_{z}}^{⁽²⁾}^{z-k}^{ₓ}^{⁽³⁾}^{(x+w/2))} (4)

Eq. (2), (3), and (4) are equations which describe the electromagnetic wave in region 1, 2, and 3 respectively. \vec{E} is electric field, k is wave vector. E_{y0} is wave amplitude. The superscripted number shows the region, and the subscripted number shows the direction. For example, k_{z}⁽²⁾ is wave vector in region 2 and in Z-axis direction, and E_{y0}⁽¹⁾ is the wave amplitude in region 1.

Next, k_{z}⁽²⁾,kₓ⁽¹⁾,kₓ⁽²⁾,kₓ⁽³⁾ are solved by using Eq. (2), (3) and (4) together with Eq. (5) (eigen function) illustrated as follows.

V=ε″ₘk₀²+i(\sqrt{(k_{z}⁽²⁾)²−ε′ₘk₀²}+tan h(w/2\sqrt{(k_{z}⁽²⁾)²−ε₂k₀²})\sqrt{(k_{z}⁽²⁾)²−ε₂k₀²}) (5

V is the eigen value and ε₂ is the permittivity of the medium in region 2. ε′ₘ is the real part of the permittivity of the grating lines. ε″ₘ is the imaginary part of the permittivity of the grating lines. Therefore, the transmittance can be expressed as follows.

$$\begin{matrix}{Transmittance}_{p = 0}^{TE} = \frac{1}{{k}_{0}} [ Re ( {{T}_{0} ( {k}_{z 0}^{( 3 )} {T}_{0} )}^{*} ) + \vert Re ( {{T}_{0} ( {α}_{0} {T}_{0} )}^{*} ) \vert ] & ( 6 ) \\ {α}_{p} ≡ {n}_{1} {k}_{0} sin ( θ ) \pm p \frac{2 π}{λ} & \\ {A}_{0} = \frac{{k}_{s 0}^{( 1 )} sin c ( {α}_{0} w / 2 )}{{tk}_{z}^{( 2 )} sin c ( {k}_{x}^{( 2 )} w / 2 )} & \\ {T}_{p} = \frac{tw}{2 Λ} ( cu + d ) {S}_{p} , u ≡ {e}^{j {k}_{z}^{( 2 )} h} , t ≡ {e}^{j {k}_{x}^{( 2 )} w / 2} & \\ {S}_{p} = sin c ( ( {k}_{x}^{( 2 )} - {α}_{p} ) w / 2 ) + sin c ( ( - {k}_{x}^{( 2 )} - {α}_{p} ) w / 2 ) & \\ c = \frac{{A}_{0} ( 1 + {U}_{3} )}{( 1 + {U}_{1} ) ( 1 + {U}_{3} ) - {u}^{2} ( 1 - {U}_{1} ) ( 1 - {U}_{3} )} & \\ {U}_{1} = \frac{w}{4 Λ {k}_{z}^{( 2 )} sin c ( {k}_{x}^{( 2 )} w / 2 )} {\sum }_{p} {k}_{zp}^{( 1 )} {S}_{p} sin c ( {α}_{p} w / 2 ) & \\ d = \frac{{A}_{0} u ( 1 - {U}_{3} )}{( 1 + {U}_{1} ) ( 1 + {U}_{3} ) - {u}^{2} ( 1 - {U}_{1} ) ( 1 - {U}_{3} )} & \\ {U}_{3} = \frac{w}{4 Λ {k}_{z}^{( 2 )} sin c ( {k}_{x}^{( 2 )} w / 2 )} {\sum }_{p} {k}_{zp}^{( 3 )} {S}_{p} sin c ( {α}_{p} w / 2 ) & \end{matrix}$$

P is the mode number. αₚ is the wave vector of the diffraction mode, P, along the X-axis direction.

(2) Finite Different Time Domain (FDTD) Method

In this method, the electromagnetic wave is expressed as a difference quotient. Next, by taking the boundary conditions into consideration, the FDTD can be used for solving the transmittance of the mask 18 with respect to the zero-order incident light 11 in TE mode.

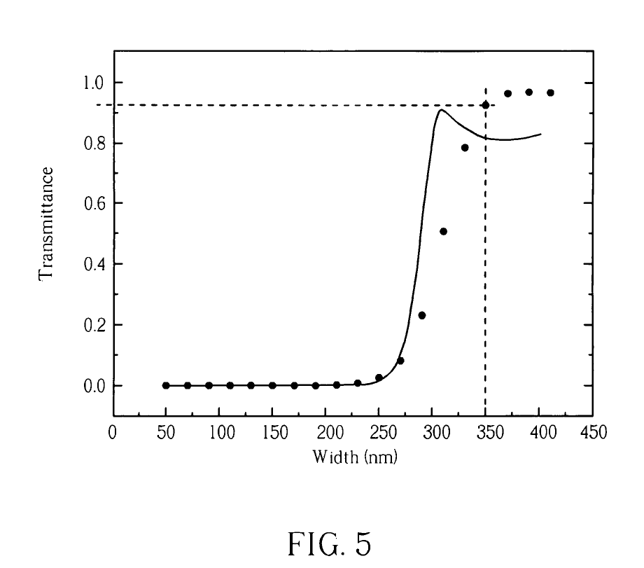

It is assumed that A=500 nm, h=380 nm, θ=0, n₁=n₂=n₃=1, and the wavelength of the incident light 11 is 670 nm. The transmittance of the mask 18 with respect to the zero-order incident light 11 in TE mode versus width W is shown in FIG. 5. The bold line in FIG. 5 illustrates the result calculated by the vector analysis method, when the material of the mark 20 is a perfect conductor. The dotted line in FIG. 5 illustrates the result calculated by the FDTD method, when the material of the mark 20 is silver.

Please refer to FIG. 5, assuming the width W of the mark 20 is 350 nm, and the material of the mark 20 is silver. As seen in FIG. 5, the theoretical value of the transmittance of the mask 18 with respect to the zero-order incident light 11 in TE mode is 0.92. According to the preferred embodiment of the present invention, 0.92 (transmittance) is high enough to enable the feedback method in the present invention to be carried out. Thereafter, the mark 20 can be made in the scale of A=500 nm, h=380 nm, W=350 nm, which is assumed above. Subsequently, a transmittance test is run to decide the experimental value of the transmittance of the mask 18 with respect to the incident light 11 in TE mode. It is assumed that the experimental transmittance is 0.9 and the energy of the refracted light 11′ in TE mode detected by the detector 24 is 9.0 mW. Therefore, the energy of the incident light 11 in TE mode can be calculated as 10 mW. The total energy of the incident light 11 which can be known by the optical power meter is 15 mW in this embodiment. Therefore, the TE/TM polarization power ratio of incident light 11 can be calculated as 2. Next, the TE/TM polarization power ratio of incident light 11 is fed back into the polarization converter 16 as the base value to adjust the radiant 10a. Then, the TE/TM polarization power ratio of incident light 11 can be adjusted before illuminating the mark 20 again. This feedback method for controlling TE/TM polarization power ratio of incident light can be operated repeatedly until the TE/TM polarization power ratio of incident light 11 is high enough.

In another embodiment of the present invention, another feedback method for controlling TE/TM polarization power ratio of incident light is provided. The feedback method will be described by utilizing the feedback system 200 as example. As shown in FIG. 2, the detector 24 is used to detect the energy of reflected light 11″ in a specific polarized direction, such as the energy of reflected light 11″ in TM mode. Therefore, the vector analysis method or the FDTD method can be used to design the mark 20 of the feedback system 200. The width, the thickness and the pitch of the mark 20 can be determined due to the reflective index of the mask 18 with respect to the specific polarized mode of the incident light 11. Afterwards, the mark 20 can be made. Then, the mask 18 undergoes a reflective test to get the experimental value of the reflective index of the mask 18 with respect to the incident light 11 in a specific polarized mode. According to the preferred embodiment, the pitch of the mark 20 is smaller than the wavelength of the radiant 10a. When the feedback method is operated with the feedback system 200, the energy of reflected light 11″ in TM mode is detected by the detector 24. Based on the experimental value of the reflective index of the mask 18 with respect to the incident light 11 and the energy of reflected light 11″ in TM mode, the energy of the incident light 11 in TM mode can be calculated. If the total energy of the incident light 11 is known by the optical power meter, then the TE/TM polarization power ratio of incident light 11 can be calculated. Thereafter, the TE/TM polarization power ratio of incident light 11 is fed into the polarization converter 16 as the base value to adjust the radiant 10a. Then, the TE/TM polarization power ratio of incident light 11 can be adjusted before illuminating the mark 20 again. This feedback method for controlling TE/TM polarization power ratio of incident light can be operated repeatedly until the TE/TM polarization power ratio of incident light 11 is high enough.

Those skilled in the art will readily observe that numerous modifications and alterations of the device and method may be made while retaining the teachings of the invention.

What is claimed is:

1. A feedback method for controlling polarization power ratio of incident light, comprising:
providing a mask having a mark;
illuminating the mark with incident light;
detecting reflected light or refracted light from the illuminated mark to obtain a first parameter;
processing the first parameter to become a second parameter; and
adjusting polarization power ratio of the incident light from the second parameter.

2. The method of claim 1, wherein the polarization power ratio of the incident light is adjusted by feeding back the second parameter into a polarization converter.

3. The method of claim 1, wherein the mark is made of grating lines, and the grating lines comprise a pitch.

4. The method of claim 3, wherein the pitch is smaller than the wavelength of the incident light.

5. The method of claim 1, wherein the first parameter comprises energy of the refracted light in TE (transverse-electric) mode.

6. The method of claim 1, wherein the first parameter comprises energy of the reflected light in TM (transverse-magnetic) mode.

7. The method of claim 1, wherein the second parameter is TE/TM polarization power ratio of the incident light.

8. The method of claim 1, wherein the incident light illuminates the mark by an incident angle not equal to 0.

9. The method of claim 8, wherein the incident angle is greater than zero degrees.

10. The method of claim 1, wherein the incident light is formed by off-axis illumination.

11. A feedback controlling system comprising:
an incident light used to illuminate a mark on a mask;
a polarization converter used to control polarization power ratio of the incident light;
a detector used to detect reflected light or refracted light from the illuminated mark to get a parameter; and
a processor used to calculate the parameter and send a feedback signal to the polarization converter to adjust the polarization power ratio of the incident light.

12. The system of claim 11, wherein the mark is made of grating lines, and the grating lines comprise a pitch.

13. The system of claim 12, wherein the pitch is smaller than the wavelength of the incident light.

14. The system of claim 11, wherein the parameter comprises energy of the refracted light in TE (transverse-electric) mode.

15. The system of claim 11, wherein the parameter comprises energy of the reflected light in TM (transverse-magnetic) mode.

16. The method of claim 11, wherein the incident light illuminates the mark by an incident angle not equal to 0.

17. The method of claim 16, wherein the incident angle is greater than zero degrees.

18. The method of claim 11, wherein the incident light is formed by off-axis illumination.
